(19) United States
(12) Patent Application Publication
(10) Pub. No.: US 2006/0186136 A1
(43) Pub. Date: Aug. 24, 2006

(54) Beer dispensing apparatus

(76) Inventors: Albert Wauters, Destelbergen (BE); Hans Donker, Eindhoven (NL); Ian Anderson, Burwell (GB); Christine A Fraser, Cambridge (GB); Stephen J Grimwade, Upwood (GB)

Correspondence Address: James W Kerr;Interbrew S.A, 303 Richmond Street, London Ontario, Canada, N6B 2H8, CA

(21) Appl. No.: 10/536,977

(22) PCT Filed: Nov. 25, 2003
(86) PCT No.: PCT/IB03/05413

§ 371 Date: Mar. 16, 2006

(30) Foreign Application Priority Data
Nov. 29, 2002 (GB) 0227943.8
Nov. 29, 2002 (GB) 0227944.6
Oct. 24, 2003 (GB) 0324903.4

(51) Int. Cl. B65D 35/56; B67D 5/42

(52) U.S. Cl. 222/105; 222/386.5

(57) ABSTRACT

A tap adapter suitable for use in dispensing an alcohol beverage from a keg which tap adapter has a hollow arm adapted for mounting to a valve assembly in fluid flow communication with a beverage dispensing valve in the valve assembly. The arm may contain a dispensing tube. A first end portion of the arm is adapted to releasably connect to the beverage dispensing valve to open the valve and has a tap permitting beverage to flow through the hollow arm and out the tap. An air line passageway is adapted to be connected to a second valve in sealed fluid flow communication therewith passing through the valve assembly or keg. A source of air is connected to the air line passageway for supplying pressurized air to the second valve and into the keg. A relief valve is provided which can be opened to allow air to pass into the discharge tube upstream of the discharge end portion whereby the beverage in the discharge tube downstream of the relief valve freely flows out of the discharge end portion.

### FIELD OF THE INVENTION

The present invention relates to an alcohol beverage dispensing apparatus and in particular, relates to a tap adapter for mounting with a container or keg.

### BACKGROUND OF THE INVENTION

It is known to contain alcohol, such as wine in bags contained in a cardboard type container where the wine feeds by gravity through a shut off tap mounted outside the container. Further, it is known to fill a bag with beer in a keg. In the case of a beer keg, pressure is applied to the bag to dispense the beer from the bag and out of the keg. Further, the bag is inserted into the keg container prior to the beer being filled into the bag through a valve assembly.

However, there is a need for the user to be able to control the dispensing of the beer from the keg out through a tap connected to the valve assembly. For example, particularly in special circumstances where the beer is to be dispensed directly from the keg. These special circumstances occur when the keg is utilized at an outdoor activity or where a consumer does not desire to purchase a home beer dispensing system and still desires to make use of beer stored in a keg.

Alternatively, in a home beverage dispensing system suitable for use in dispensing beer, the keg is a replaceable item and the tap is an item that forms part of the beer dispensing apparatus. This raises a cleansing issue for the tap between keg refills. Also there is a need for the tap to be readily connectable with the beer keg.

Typically, the dispensing apparatus comprises a tap that controls the flow of the beverage through a dispense tube. When the tap is closed, the beverage does not flow through the dispense tube. However there is usually a portion of the dispense tube that is located downstream of the tap closure. Upon tap closure, beer downstream of the tap does not readily flow out the dispense tube but instead slowly drips from the tube slowing the dispense process and possibly foaming the beverage. Accordingly, there is a need to address the problem associated with potential dripping of the beverage from the dispense tube after the tap is closed.

### SUMMARY OF THE INVENTION

It is an object of the present invention to provide a tap adapter for use in an alcohol beverage dispensing apparatus which provides for a simple and reliable interconnection between alcohol stored in a keg and a tap located externally of the housing for the beverage dispensing apparatus.

It is another object of the present invention to provide a tap adapter which has an interchangeable cartridge that provides for a new clean tap adapter cartridge with every keg refill.

It is another object of the present invention to provide a tap adapter which provides for a simple and reliable interconnection between alcohol stored in a keg and a tap forming part of the adapter.

It is a further object of the present invention to provide a tap adapter that provides an air supply for providing pressurized air into the keg to assist in dispensing alcohol from the keg.

Yet a further object is desired to provide a tap adapter for use in an alcohol beverage dispensing apparatus that is not subject to dripping of alcohol beverage from the dispense apparatus after the tap is closed.

The present invention relates to a tap adapter suitable for use in dispensing an alcohol beverage from a keg and a valve assembly mounted to the keg, which may be stand alone or in a dispensing apparatus. The tap adapter has a hollow arm adapted for mounting to the valve assembly in fluid flow communication with a beverage dispensing valve in the valve assembly. The hollow arm has a first end portion and a second end portion remote therefrom. The first end portion is adapted to releasably connect to the beverage dispensing valve to open the valve. The adapter has a tap connected to the remote end of the hollow arm and is operable between a closed position shutting off flow of beverage through the hollow arm and an open position permitting beverage to flow through the hollow arm and out the tap. The adapter may have an air line passageway adapted to be connected to a second valve mounted either in the valve assembly or directly to the keg in sealed fluid flow communication therewith.

In one embodiment, the adapter has a pump connected to the air line passageway for supplying pressurized air to the second valve. Consequently, the tap adapter of the present invention has the advantages associated with a stand alone unit adapted to permit the beverage to be dispensed from the keg remote of any power supply. Hence the keg and tap adapter become a portable unit and circumvent the need for an alcohol beverage dispensing appliance.

The air line passageway has a first end portion that connects to and opens the second valve and has a second end portion connected to the pump. The air line passageway may have an air valve adjacent the second end portion for connection with the pump. Preferably, the second valve is contained within the valve assembly that also houses the first valve. Preferably the pump is a manual pump and may comprise a lever or bellows that may be manually operated to supply pressurized air.

Preferably the tap is integrally formed with the remote end portion of the hollow arm. Alternatively, the tap may be assembled to the remote end portion of the adapter. Further, the air line passageway is an integral part of the adapter.

The adapter may further include a base portion for supporting the hollow arm. The base portion has a neck adapted to releasably engage the valve assembly and an annular flange portion adapted to abut the keg.

Preferably, the tap has a cam member that rotates to close fluid flow through the hollow arm of the adapter.

The hollow arm may be separable to receive a tubular cartridge for interconnecting the tap with the beverage dispensing valve. The hollow arm may be pivotally connected adjacent the first end portion to permit for separation of the hollow arm into an upper arm portion and a lower arm portion. The lower arm portion is adapted to receive the cartridge in snap fit relation therewith.

In a further embodiment, the invention provides a tap adapter having a dispensing tube through which beverage flows through a discharge end portion. The dispensing tube also has a relief valve located upstream of the discharge end portion. The tap adapter includes a tap positioned upstream of the relief valve and the tap is moveable between an open position and a closed position. In the open position, the tap permits the flow of the beverage through the dispense tube. In the closed position the tap inhibits the flow of beverage through the dispense tube and concurrently opens the relief valve. When the relief valve is open, air is able to pass in through the relief valve and into the dispense tube upstream of the discharge end portion so that the beverage in the discharge tube downstream of the relief valve flows freely out of the discharge end portion.

By providing a relief valve upstream of the discharge end portion and immediately downstream of the tap, beverage normally trapped downstream of the tap is now able to freely flow out of the discharge end portion due to the relief valve being open and permitting air to replace the beverage as it flows out of the discharge end portion of the tube.

The dispense tube may comprise a flexible tube having an elastic wall and may comprise of a suitable material such as, for example, silicone rubber or santoprene. Preferably, the relief valve comprises a slit cut into the elastic wall and the tap is located adjacent the slit to close this slit when tap is in the open position.

The tap has an actuating member that covers the slit when the tap is in an open position. The actuating member pivots during tap closure to pinch the elastic wall of the dispense tube upstream of the slit. As the walls of the dispense tube collapsed during pinching, the slit is forced open to permit air to enter into the dispense tube upstream of the dispense end portion and downstream of the pinched elastic wall. Preferably the tap pivots between its open and closed positions at a pivot point positioned immediately upstream of the relief valve.

Therefore, in accordance with one aspect of the present invention, there is provided a tap adapter for use in dispensing an alcohol beverage from a keg having a self-contained bag filled with an alcohol beverage. The keg has a neck and a valve assembly mounted to the neck of the keg where the valve assembly has a first valve through which beverage is dispensed from the keg and one of the keg and valve assembly has a second valve through which pressurized air is feed into the keg against an outside wall of the bag. The tap adapter comprises a hollow arm, a tap, an air line passageway and a pump. The hollow arm is adapted for releasably mounting in sealed relation with the valve assembly in fluid flow communication with the first valve. The hollow arm has a first end portion and a second end portion remote therefrom. The first end portion is adapted to connect to the first valve to open the valve. The tap is connected to the remote end of the hollow arm. The tap being operable between a closed position shutting off flow of beverage through the hollow arm and an open position permitting beverage to flow through the hollow arm and out the tap. The air line passageway is adapted to be connected to the second valve in sealed fluid flow communication therewith. The pump is connected to the air line passageway for supplying pressurized air to the second valve.

In an alternative aspect of the invention, the air line passageway has a second end portion housing an air valve that is adapted to be connected to a pressurized air supply.

In accordance with another aspect of the present invention there is provided a tap adapter for use in dispensing an alcohol beverage from a keg containing the alcohol beverage. The keg has a neck and a valve assembly mounted to the neck of the keg. The valve assembly has a first valve through which beverage is dispensed from the keg. The tap adapter comprises a hollow arm adapted for releasably mounting in sealed relation with the valve assembly. The tap adapter has a flexible dispensing tube supported in the hollow arm through which the beverage flows. The dispensing tube has a first end portion connected with a first valve for receiving the beverage. The dispensing tube has a second end portion from which the beverage is dispensed. The dispensing tube has a relief valve located between the first and second end portions. The tap adapter has a tap connected to the hollow arm and is movable between an open position and a closed position. The tap in the open position closes the relief valve and permits the beverage to flow through the dispense tube. The tap in the closed position engages the dispense tube upstream of the relief valve to pinch the dispense tube closed and thereby inhibits flow of beverage through the dispense tube. The tap also in the closed position opens the relief valve allowing air to pass into the dispense tube upstream of the second end portion whereby the beverage in the discharge tube downstream of the relief valve continues to freely flow out of the second end portion.

In accordance with yet a further aspect of the present invention there is provided an alcohol beverage dispensing apparatus. The apparatus comprises a keg, a valve assembly, a housing, dispensing adapter, and a tap. The keg contains an alcohol beverage and has a neck. The valve assembly is mounted to the neck of the keg. The valve assembly has a first valve through which beverage is dispensed from the keg. The keg and valve assembly are positioned in the housing during beverage dispensing. The dispensing adapter is releasably mounted in sealed relation with the valve assembly in fluid flow communication with the first valve. The dispenser adapter has a hollow arm having a first end portion and a second end portion remote therefrom. The first end portion is connected to the first valve to open the valve. The hollow arm extends from the valve assembly out through the housing to position the remote end portion of the hollow arm outside of the housing. The tap is connected to the remote end of the hollow arm. The tap is operable between a closed position shutting off flow of beverage through the hollow arm and an open position permitting beverage to flow through the hollow arm and out the tap.

### BRIEF DESCRIPTION OF THE DRAWINGS

For a better understanding of the nature and objects of the present invention reference may be had to the accompanying diagrammatic drawings in which:

FIG. 1 is a front elevation view of a home beer dispensing apparatus in accordance with the present invention;

FIG. 2 is a side elevation view of the home beer dispensing apparatus;

FIG. 3 is broken away perspective view of the keg showing the valve and spear assembly mounted within the keg;

FIG. 4 is a sectional side view of the valve and spear assembly as shown in FIG. 3;

FIG. 5 is a plan view of the valve body of the valve assembly;

FIG. 6 is a sectional side view of the tap adapter mounted to the keg inside a dispensing apparatus;

FIG. 7 is a side sectional view of the tap adapter of FIG. 6 showing the tap pivoted open; and,

FIGS. 8 and 9 are perspective views of the tap adapter respectively showing the hollow arm in closed and open positions.

FIG. 10 is a side view of another embodiment for the tap adapter.

FIGS. 11 and 12 are perspective views of a tap and flexible dispensing tube showing the tap respectively in open and closed positions.

### DETAILED DESCRIPTION OF THE INVENTION

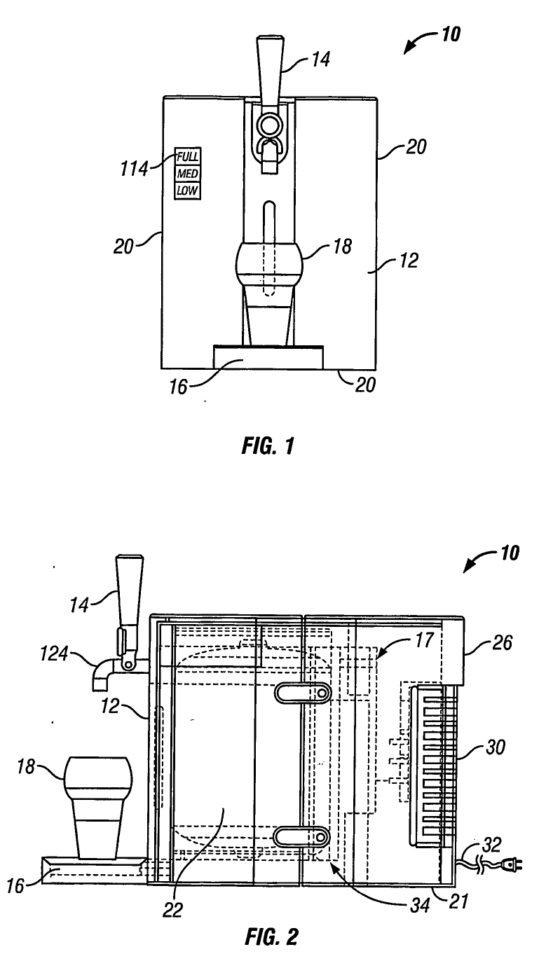

Referring to FIGS. 1 and 2 there is shown a home beer dispensing apparatus, appliance or unit 10. The dispensing apparatus 10 is primarily intended for use in domestic kitchens but may also be used in utility rooms, garages, domestic bars, caravans, etc. While the preferred embodiment relates to dispensing beer, alternatively carbonated solutions or other alcohol beverages may be dispensed by apparatus 10.

The home beer dispensing apparatus 10 has a front wall 12 and a dispensing tap 14 protruding forward of the front wall 12. A drip tray 16 also protrudes forward of the front wall 12 and is adapted to support an open glass container 18 below the dispensing tap 14. The home beer dispensing apparatus 10 further has a base 21 adapted to rest on a counter top. The front wall 12 is an extension of two pivoting side walls 20 which may be moved between closed and open positions to allow the keg 22 (see FIG. 2 in broken lines) to be inserted into the housing of the home beer dispensing apparatus 10.

The housing 17 of the home beer dispensing apparatus 10 further includes a top wall 24 and a rear wall 26. The rear wall 26 has a grill 30 that permits for air circulation within the home beer dispensing apparatus 10. An electrical cord 32 extends through the rear wall 26 of the apparatus 10 to provide a connection into a main electrical supply to supply electrical power to the electrical components housed within the unit 10. Alternatively, a 12 Volt DC supply input may be used.

The dispensing apparatus 10 has a cooling system 34 located behind and below keg 22 that is adapted to cool beer in keg 22 when keg 22 is placed into dispensing apparatus 10.

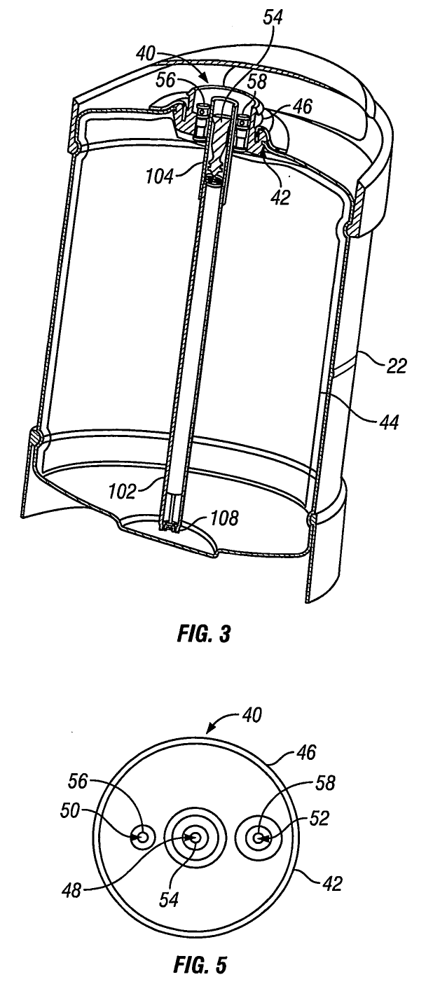

Referring to FIGS. 3 through 5, the preferred valve assembly 40 and spear 102 are shown.

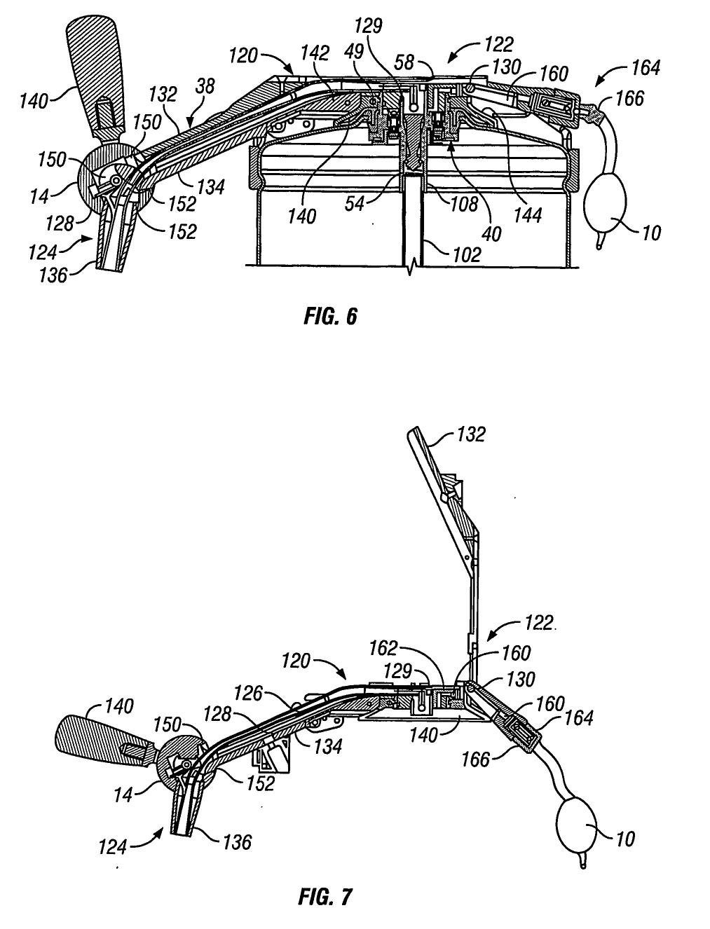

The valve assembly 40 is adapted to fit into a raised collar aperture 42 of keg 22. The valve assembly 40 has an annular shaped body 46 that is secured in the aperture 42. The valve body 46 has an annular groove 47 and flange 49 that is adapted to extend above the keg 22 for mating with a tap dispensing adapter 38 (FIG. 6) connected to tap 14.

The valve body 46 has a first passageway 48, a second passageway 50, and a third passageway 52 spaced apart from each other and extending through the valve body 46. As best seen in FIG. 6, the first passageway 48 is centrally disposed or located within the valve body 46 and the second and third passageways 50 and 52 are spaced radially of the first central passageway 48.

The valve assembly includes a first valve 54, a second valve 56 and a third valve 58. The first valve 54 is seated in the first passageway 48 for controlling the flow of the beverage or beer through the first passageway 48 into and out of the bag 44.

The second valve 56 is seated in the second passageway 50 for controlling the flow of gas such as carbon dioxide through the second passageway 50 into and out of the bag.

The third valve 58 is seated in the third passageway 52 and controls the flow of gas through the third passageway 52 into and out of the keg 22 exterior to the bag 44.

Each valve, 54, 56, and 58 has a valve actuator or stem 60 that effectively opens and closes the valve. The valve stem 60 extends away from the valve body 46 by a different predetermined distance for each of valves 54, 56 and 58. Each of the valves 54, 56 and 58 further include a valve head 70 connected to the valve stem 68. The valve head 70 carries an O-ring 72 which is adapted to seal the valve head within the respective passageway. A spring 74 urges the valve head 70 into sealing engagement with its corresponding passageway. The valve stems 68 are accessible from outside the keg 22 for moving each valve head 70 into an open and closed position to respectively enable and inhibit fluid flow through passageways 48, 50 and 52.

The valve body 46 has an annular recessed groove 62 recessed in an inner wall 64 of the valve body 46. The inner wall 64 is positioned within the keg 22. The recessed groove 62 is adapted for receiving the neck 66 of bag 44 in press fit relation therewith. The annular recessed groove 62 has a diameter that surrounds the first and second passageways 48 and 50. The third passageway 52 is located outside of the diameter of the recessed groove 62 and as a result, the third passageway 52 is located outside of the bag 44.

The keg 22 has a collar flange 82 which defines the raised collar aperture 42, the valve body 46 has an outer peripheral wall 63 with a recessed groove 61 extending around the outer wall 63. An intermediate ring or bung 80 is adapted to seat the valve body 46 within the raised collar aperture 42. The intermediate ring 80 has inner and outer walls 84, 86. The inner wall 84 has flange 88 extending inwardly thereof that is adapted to fit into the recessed groove 61 of the outer wall 63 of the valve body 46. The outer wall 86 of the intermediate ring 80 has a resilient barb 90 and a locking flange 92 spaced from the barb 90 so as to define an outer locating groove 94 into which the collar flange 82 of the keg 22 is held. The barb 90 is adapted to pass through the aperture 42 and spring back into locking engagement with the collar flange 82 so as to lock the valve assembly 40 in place. Special tools are required to remove the valve assembly 40 and the intermediate ring 80 from the collar flange 82 of the keg 22 once the keg 22 is returned to the brewery for refilling.

In order to ensure that the contents of the keg 22 have not been tampered with, the keg 22 has an anti-tamper ring 96 that overlays the intermediate ring 80, a portion of the keg 22 and a portion of the valve body 46. The intermediate ring 80 has an aperture 98 that passes completely through the intermediate ring 80 to provide a vent passageway. The anti-tamper ring 96 has a flange part 100 that is inserted into the vent aperture 98 of the intermediate ring 80. In the event the anti-tamper ring 96 is removed from the keg 22, vent aperture 98 is open and the contents or any pressure within the keg 22 is released. Further, as a pressure relief feature, the anti-tamper ring 96 is designed to release from aperture 98 when pressure in keg 22 exceeds a predetermined valve to vent pressurized air through aperture 98.

Referring to FIGS. 6 to 9, the tap adapter 38 of the present invention is shown in more detail. The tap adapter 38 is mounted to the valve assembly 40 in fluid flow communication with the first valve 54. This attachment is a snap action sealed attachment on inner and outer walls of valve flange 49.

The dispenser adapter 38 has a hollow arm 120 that has a first end portion 122 adjacent the valve assembly 40 and a second end portion 24 which is remote therefrom. The first end portion 122 is connected to the first valve 54 so as to open the valve 54. This connection is made when the adapter is snap fitted downwardly onto the valve neck flange 49. The hollow arm 120 extends from the valve assembly 40 out through the housing 17 to a position where the remote end portion 124 of the hollow arm 120 is outside of the housing 17.

As better shown in FIGS. 7 and 9, the hollow arm 120 is separable by a hinge point 130. The arm 120 is separable into an upper arm portion 132 and a lower arm portion 134. As shown in FIG. 9, lower arm portion 132 carries the tap 14 integral therewith. The lower arm portion 134 comprises a half hollowed out passageway 137 (see FIG. 9). Inserted into this lower arm portion 134 is a tubular cartridge 126 that has a tube 128 that interconnects the tap 14 with the first valve 54 so that the beverage may flow through the tube 128 and out the tap end 136.

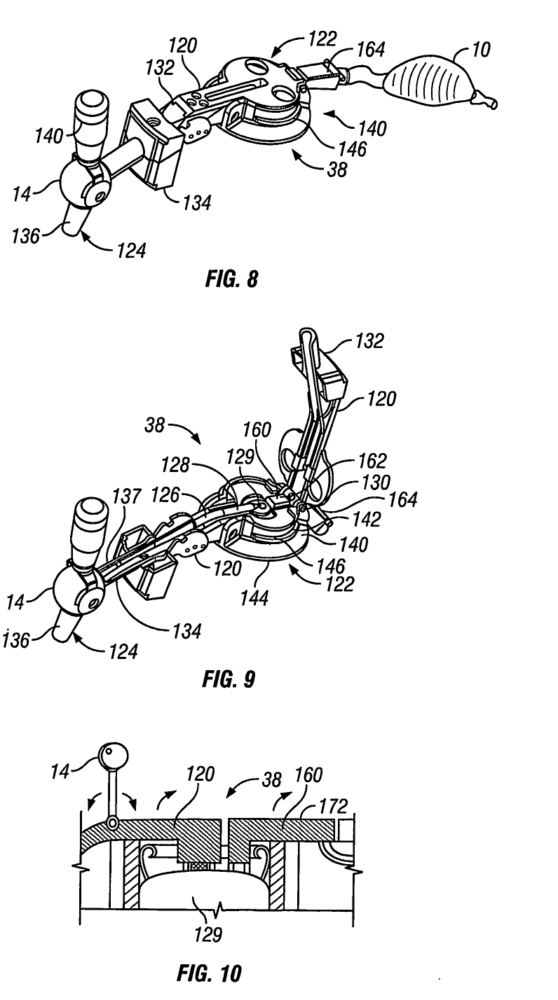

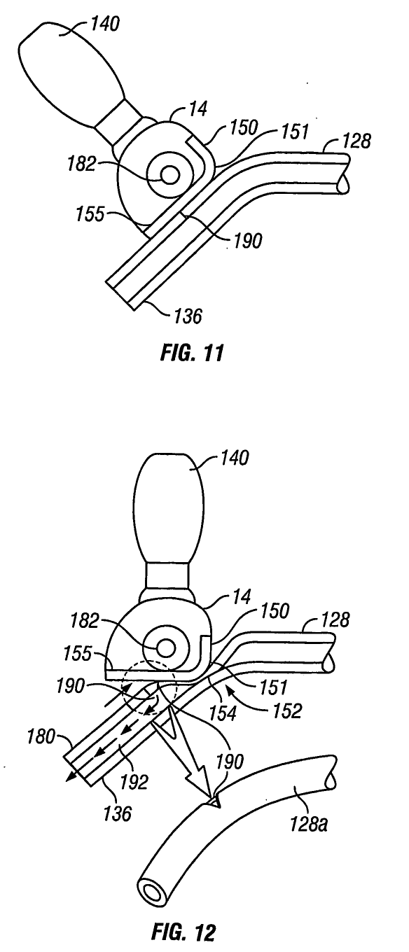

The cartridge 126 is in effect a frame like member which is adapted to be snap fitted into place with the lower arm portion 134. The cartridge 126 also carries the tube 128 therethrough for connection into the first end portion 122 of the hollow arm 120 so that when the cartridge is inserted into the hollow arm 120, and the hollow arm is subsequently mounted onto the valve assembly 40, one end 129 of the tube 128 sealingly engages passageway 48 and opens valve 54 so that beverage may be dispensed through valve 54 and into the tube 128. The upper arm portion 132 as shown in FIG. 9 may then be snapped back into place relative to the lower arm portion 132. Alternatively, the upper arm portion 132 and the lower arm portion 134 may be held in place once the doors 20 of the appliance are closed and posts 170 (FIG. 8) are brought into engagement with both the upper and lower portions 132, 134 of the hollow tube 120 to thereby hold them together.

The adapter 38 is provided with a base portion 140 for supporting the hollow arm 120. The base portion 140 has a neck or supporting ring 142 that is adapted to surround and releasably engage the valve neck flange 49. The base portion 140 further includes an annular flange portion 144 which provides an inverse shape of a saucer that is adapted to abut the top surface of the keg 22 and to be supported thereon.

The base portion 140 has locking spring members 146 (see FIG. 9) that engage the valve neck groove 47 and are movable to release the adapter 38 from the valve assembly 40.

Tap 14 is connected to the remote end 124 of the hollow arm 120 and in particular the lower arm portion 134. The tap is operable between a closed position to shut off the flow of beverage through the hollow arm as shown in FIG. 6 and an open position permitting beverage to flow through the hollow arm and out the tap 14 as shown in FIG. 9. The tap 14 also forms an integral part of the hollow arm 120 and in particular the lower portion 134. The tap 14 has a handle 140 that is pivotally connected to a cam member 150 so as to rotate cam member 150 into pinching engagement against tube 128 as indicated at pinching point 152. The handle will be normally biased in this position and may be drawn forward to release cam member 150 from the tube 128 and thereby open the tube at point 152 and permit beverage to be dispensed along the tube 128 contained within the hollow arm 120 from the valve assembly 40.

Turning to the embodiment as shown in FIG. 12, as the tap 14 is biased forward (to the right in FIG. 12) the cam member 150 pinches the elastic wall 180 of the flexible tube 128 together to thereby restrict flow of beverage through the tube 128. This is referred to throughout the specification and claims as the tap 14 being in the closed position. The flexible tube 128 may comprise a silicone rubber material or a santoprene material. The tube 128 is further provided with a relief valve 190. The relief valve 190 comprises a slit cut into the wall 180 of the tube 128. The slit 190 is cut parallel to the pinching direction of corner 151 of cam member 150. When the tap 14 is in the closed position, shutting off the flow of beverage through the dispense tube 128, the relief valve slit 190 is open.

The tap 14 is pivoted about point 182 immediately upstream of the relief valve 190 between its open and closed positions. As seen in FIG. 8, the tap 14 is in the open position permitting flow of beverage through tube 128. Also, in this open position the surface 155 of cam member 150 of the tap 14 is adapted to cover or extend over the relief valve 190 to ensure that the relief valve 190 is closed. With tap 14 in its open position, opposing walls between the slit 190 in the tube 128 contact each other preventing beverage from escaping through the closed slit 190.

When the tap 14 is pivoted to its closed position shown in FIG. 9, the deflection or pinching of the tube 128 at point 154 deflects the elastic wall 180 adjacent the slit 190. This effectively results in the slit 190 opening as illustrated by the bent tube showing the V-shaped notched section in relief valve 190 for the tube 128A. As a result, air as represented by arrows 192 is permitted to enter in through the slit of relief valve 190 and move downstream towards the discharge end 136. Consequently any beverage contained or located in the tube 128 downstream of the pinched closure 152 readily flows out from the discharge end 136 of the dispensing tube 128 when relief valve 190 is open and tube 128 is pinched closed.

Turning again to FIGS. 6 to 9, the dispensing adapter 38 includes an air line passageway 160 adapted to be connected to a second air valve 58 in fluid flow communication. The air line passageway 160 has a first end or cap member 162 that connects to and opens the second valve 58 when the adapter 38 is snap fitted onto the valve system 40. The air line passageway 160 has a second end portion 164 having a one way air valve 166 that is normally shut and that is opened when connected to a manually operable bellows air pump 10. Manual squeezing of pump 10 supplies air under pressure to the inside of keg 22 against bag 44. Alternatively, valve 166 is opened when connected to a pressurized air supply (not shown). The air line passageway 160 is an integral part of the adapter 38.

The adapter 38 of the present invention has many advantages. In particular, the adapter 38 can be sold as a separate part for use alone or as part of a dispensing apparatus to a consumer and the cartridge 126 may be sold as a replacement cartridge with each keg 22 refill for insertion into adapter 38 so as to provide a sanitary dispensing medium for the beverage. The cartridge 126 is inserted into the adapter 38 and the adapter 38 is moved into its closed position and snapped onto the keg neck 47. Because the adapter carries the tap 14 which is in a closed position, the snapping of adapter 38 onto the valve assembly 40 of the keg 22 in sealing relation therewith opens valve 54 and provides for a simple and reliable connection that does not result in any loss of beverage. At this time, the air supply line 160 is connected to the air valve 58 of the valve assembly 40. The keg 22 is ready for use as a portable free standing unit. In an alternative embodiment, the keg 22 is then placed into the dispensing apparatus 10 and the air valve 166 of the air line passageway 160 is connected to the air supply. At this time, the doors or pivoting side walls 20 of the dispensing apparatus 10 are closed bringing the posts 170 into supporting relation against the upper and lower arm portions 132, 134.

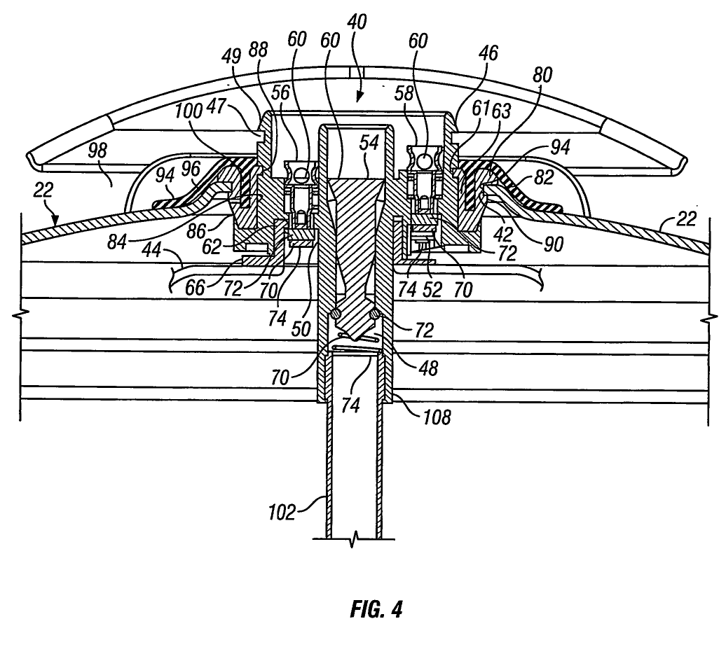

The adapter 38 is now ready to dispense beverage by drawing handle 148 forward releasing the cam 150 from pinching the tube 128 allowing the beverage to flow therethrough out through valve 54. It should be understood that pressure is applied against the bag 44 (FIGS. 3 and 4) in through the air line passageway 160 and through the valve 58 of the valve assembly 40 by manual operation of pump 10.

What is claimed is:

1. An alcohol beverage dispensing apparatus comprising:
a keg for containing an alcohol beverage, the keg having a neck;
a valve assembly mounted to the neck of the keg, the valve assembly having a first valve through which beverage is dispensed from the keg;
a housing in which the keg and valve assembly are positioned during beverage dispensing;
a dispensing adapter mounted to the valve assembly in fluid flow communication with the first valve, the dispenser adapter having a hollow arm having a first end portion and a second end portion remote therefrom, the first end portion being releasably connected in sealed relation with the first valve to open the valve, and the hollow arm extending from the valve assembly out through the housing to position the remote end portion of the hollow arm outside of the housing; and,
a tap connected to the remote end of the hollow arm, the tap being operable between a closed position shutting off flow of beverage through the hollow arm and an open position permitting beverage to flow through the hollow arm and out the tap.

2. The dispensing apparatus of claim 1 wherein;
the valve system supports a bag within the keg filled with the beverage, the valve system including a second valve through which pressurized air is injected into the keg against an outside wall of the bag; and,
the dispensing adapter includes an air line passageway adapted to be connected to the second valve in sealed fluid flow communication therewith, the air line passageway having a first end portion that connects to and opens the second valve, and the air line passageway having a second end portion housing an air valve that is adapted to be connected to a pressurized air supply.

3. The dispensing apparatus of claim 2 wherein the air line passageway is an integral part of the adapter.

4. The dispensing apparatus of claim 1 wherein:
the valve assembly has a valve neck portion that extends beyond the neck portion of the keg; and,
the adapter has a base portion for supporting the hollow arm, the base portion comprising a neck adapted to surround and releasably engage the valve neck and an annular flange portion adapted to abut the keg.

5. The dispensing arm of claim 4 wherein the base portion has spring locking members that engage the valve neck and are movable to release the adapter from the valve assembly.

6. The dispensing apparatus of claim 1 wherein the tap forms an integral part of the hollow arm of the adapter.

7. The dispensing apparatus of claim 1 wherein the tap has a cam member that rotates to close fluid flow through the hollow arm of the adapter.

8. The dispensing apparatus of claim 6 wherein the hollow arm is separable to receive a tubular cartridge for interconnecting the tap with the first valve and through which the beverage is dispensed.

9. The dispensing apparatus of claim 8 wherein the hollow arm is pivotally connected adjacent the first end portion to permit for separation of the hollow arm into an upper arm portion and a lower arm portion.

10. The dispensing apparatus of claim 9 wherein the lower arm portion is adapted to receive the cartridge in snap fit relation therewith.

11. The dispensing apparatus of claim 9 wherein the housing has position locating posts that engage the upper and lower arm portions of the hollow arm to hold them together.

12. The dispensing apparatus of claim 1 wherein the hollow arm supports an insertable tubular cartridge having a tube through which the beverage flows.

13. The dispensing apparatus of claim 1 wherein the tap has a cam member that rotates to close fluid flow through the tubular arm by pinching the tube closed.

14. A tap adapter for use in dispensing an alcohol beverage from a dispensing apparatus having a keg for containing an alcohol beverage, the keg having a neck, a valve assembly mounted to the neck of the keg, the valve assembly having a first valve through which beverage is dispensed from the keg, and a housing in which the keg and valve assembly are positioned during beverage dispensing, the tap adapter comprising:
a hollow arm adapted for releasably mounting in sealed relation with the valve assembly in fluid flow communication with the first valve, the hollow arm having a first end portion and a second end portion remote therefrom, the first end portion adapted to connect to the first valve to open the valve; and,
a tap connected to the remote end of the hollow arm, the tap being operable between a closed position shutting off flow of beverage through the hollow arm and an open position permitting beverage to flow through the hollow arm and out the tap.

15. The tap adapter of claim 14 wherein;
the valve system supports a bag within the keg filled with the beverage, the valve system including a second valve through which pressurized air is injected into the keg against an outside wall of the bag; and,
the dispensing adapter includes an air line passageway adapted to be connected to the second valve in sealed fluid flow communication therewith, the air line passageway having a first end portion that connects to and opens the second valve, and the air line passageway having a second end portion housing an air valve that is adapted to be connected to a pressurized air supply.

16. The tap adapter of claim 15 wherein the air line passageway is an integral part of the adapter.

17. The tap adapter of claim 15 wherein:
the valve assembly has a valve neck portion that extends beyond the neck portion of the keg; and,
the adapter has a base portion for supporting the hollow arm, the base portion comprising a neck adapted to releasably engage the valve neck and an annular flange portion adapted to abut the keg.

18. The dispensing arm of claim 17 wherein the base portion has spring locking members that engage the valve neck and are movable to release the adapter from the valve assembly.

19. The tap adapter of claim 14 wherein the tap forms an integral part of the hollow arm of the adapter.

20. The tap adapter of claim 14 wherein the tap has a cam member that rotates to close fluid flow through the hollow arm of the adapter.

21. The tap adapter of claim 19 wherein the hollow arm is separable to receive a tubular cartridge for interconnecting the tap with the first valve and through which the beverage is dispensed.

22. The tap adapter of claim 21 wherein the hollow arm is pivotally connected adjacent the first end portion to permit for separation of the hollow arm into an upper arm portion and a lower arm portion.

23. The tap adapter of claim 22 wherein the lower arm portion is adapted to receive the cartridge in snap fit relation therewith.

24. The tap adapter of claim 14 wherein the hollow arm supports an insertable tubular cartridge having a tube through which the beverage flows.

25. The tap adapter of claim 14 wherein the tap has a cam member that rotates to close fluid flow through the tubular arm by pinching the tube closed.

26. A tap adapter for use in dispensing an alcohol beverage from a keg having a self-contained bag filled with an alcohol beverage, the keg having a neck and a valve assembly mounted to the neck of the keg where the valve assembly has a first valve through which beverage is dispensed from the keg and one of the keg and valve assembly has a second valve through which pressurized air is feed into the keg against an outside wall of the bag; the tap adapter comprising:
a hollow arm adapted for releasably mounting in sealed relation with the valve assembly in fluid flow communication with the first valve, the hollow arm having a first end portion and a second end portion remote therefrom, the first end portion adapted to connect to the first valve to open the valve;
a tap connected to the remote end of the hollow arm, the tap being operable between a closed position shutting off flow of beverage through the hollow arm and an open position permitting beverage to flow through the hollow arm and out the tap;
an air line passageway adapted to be connected to the second valve in sealed fluid flow communication therewith; and,
a pump connected to the air line passageway for supplying pressurized air to the second valve.

27. The tap adapter of claim 26 wherein the air line passageway has a first end portion that connects to and opens the second valve, and has a second end portion connected to the pump.

28. The tap adapter of claim 26 wherein the air line passageway has an air valve adapted for connection to the pump.

29. The tap adapter of claim 26 wherein the valve assembly has a valve neck portion that extends beyond the neck portion of the keg, and the adapter has a base portion for supporting the hollow arm, the base portion comprising a neck adapted to releasably engage the valve neck and an annular flange portion adapted to abut the keg.

30. The dispensing arm of claim 29 wherein the base portion has spring locking members that engage the valve neck and are movable to release the adapter from the valve assembly.

31. The tap adapter of claim 26 wherein the tap has a cam member that rotates to close fluid flow through the hollow arm of the adapter.

32. The tap adapter of claim 26 wherein the hollow arm is separable to receive a tubular cartridge for interconnecting the tap with the first valve and through which the beverage is dispensed.

33. The tap adapter of claim 32 wherein the hollow arm is pivotally connected adjacent the first end portion to permit for separation of the hollow arm into an upper arm portion and a lower arm portion.

34. The tap adapter of claim 33 wherein the lower arm portion is adapted to receive the cartridge in snap fit relation therewith.

35. The tap adapter of claim 26 wherein the hollow arm supports an insertable tubular cartridge having a tube through which the beverage flows.

36. The tap adapter of claim 26 wherein the tap has a cam member that rotates to close fluid flow through the tubular arm by pinching the tube closed.

37. The tap adapter of claim 26 wherein the pump is manually operated.

38. A tap adapter according to claim 14 or 26 which further includes a relief valve located on said hollow arm downstream of said tap and upstream of a discharge end portion of said arm, which valve, when the tap is in a closed position inhibiting flow of beverage through the arm, is adapted to allow air to pass into the arm upstream of said discharge end portion whereby the beverage in the arm downstream of said relief valve freely flows out the discharge end portion.

39. A tap adapter according to claim 38 wherein the tap is positioned adjacent the relief valve and closes the relief valve when the tap is in the open position.

40. A tap adapter for use in dispensing an alcohol beverage, the tap adapter comprising:
a dispensing tube through which the beverage flows having a discharge end portion, and the dispensing tube having a relief valve located upstream of the discharge end portion; and,
a tap positioned upstream of the relief valve, the tap being movable between an open position and a closed position, the tap in the open position permitting flow of the beverage through the dispense tube, and the tap in a closed position inhibiting flow of the beverage through the dispense tube and opening the relief valve allowing air to pass into the dispense tube upstream of the discharge end portion whereby the beverage in the discharge tube downstream of the relief valve freely flows out the discharge end portion.

41. The tap adapter of claim 40 wherein the tap is positioned adjacent the relief valve and closes the relief valve when the tap is in the open position.

42. The tap adapter of claim 40 wherein the dispense tube has an elastic wall and the relief valve comprises a slit extending through the elastic wall.

43. The tap adapter of claim 42 wherein the tap has an actuating member that covers the slit when the tap is in the open position and that pivots to pinch the elastic wall of the dispense tube upstream of the slit so as to close the dispense tube upstream of the slit and to open the slit of the elastic wall of the dispense tube to permit air to enter into the dispense tube upstream of the dispense end portion and downstream of the pinched elastic wall.

44. The tap adapter of claim 43 wherein the tap pivots between the open and closed positions at a pivot point positioned immediately upstream of the relief valve.

45. A tap adapter for use in dispensing an alcohol beverage from a keg containing the alcohol beverage, the keg having a neck and a valve assembly mounted to the neck of the keg, the valve assembly having a first valve through which beverage is dispensed from the keg, the tap adapter comprising:
a hollow arm adapted for releasably mounting in sealed relation with the valve assembly;
a flexible dispensing tube supported in the hollow arm through which the beverage flows, the dispensing tube having a first end portion connected with the first valve for receiving the beverage, the dispensing tube having a second end portion from which the beverage is dispensed, and the dispensing tube having a relief valve located between the first and second end portions; and,
a tap connected to the hollow arm and movable between an open position and a closed position, the tap in the open position permitting the beverage to flow through the dispense tube, and the tap in the closed position engaging the dispense tube upstream of the relief valve to pinch the dispense tube closed inhibiting flow of the beverage through the dispense tube and to open the relief valve allowing air to pass into the dispense tube upstream of the second end portion whereby the beverage in the discharge tube downstream of the relief valve continues to freely flow out the second end portion.

46. The tap adapter of claim 45 wherein the dispense tube has an elastic wall and the relief valve comprises a slit extending through the elastic wall.

47. The tap adapter of claim 46 wherein the tap has an actuating member that covers the slit when the tap is in the open position and that pivots to pinch the elastic wall of the dispense tube upstream of the slit and to open the slit of the elastic wall of the dispense tube to permit air to enter into the dispense tube upstream of the dispense end portion and downstream of the pinched elastic wall.

48. The tap adapter of claim 47 wherein the tap pivots between the open and closed positions at a pivot point positioned immediately upstream of the relief valve.

49. The tap adapter of claim 45 wherein the valve assembly supports a bag within the keg filled with the beverage, the valve assembly including a second valve through which pressurized air is injected into the keg against an outside wall of the bag.

50. The tap adapter of claim 49 wherein:
the valve assembly has a valve neck portion that extends beyond the neck portion of the keg; and,
the adapter has a base portion for supporting the hollow arm, the base portion comprising a neck adapted to releasably engage the valve neck and an annular flange portion adapted to abut the keg.

51. The tap adapter of claim 45 wherein the tap forms an integral part of the hollow arm of the adapter.
